(19) United States
(12) Patent Application Publication
(10) Pub. No.: US 2020/0192832 A1
(43) Pub. Date: Jun. 18, 2020

(54) INFLUENCING PROCESSOR GOVERNANCE BASED ON SERIAL BUS CONVERGED IO CONNECTION MANAGEMENT

(71) Applicant: Intel Corporation, Santa Clara, CA (US)

(72) Inventors: Rajaram Regupathy, Bangalore (IN); Abdul Ismail, Beaverton, OR (US); Peter Ewert, Hillsboro, OR (US); Abhilash K V, Bangalore (IN); Sajal Kumar Das, Bangalore (IN)

(21) Appl. No.: 16/797,436

(22) Filed: Feb. 21, 2020

(51) Int. Cl. G06F 13/16; G06F 13/42

(52) U.S. Cl. CPC G06F 13/1668; G06F 2213/0026; G06F 2213/0042; G06F 13/4282

(57) ABSTRACT

Systems, apparatuses and methods may provide for technology that collects state data from a plurality of input/output (TO) drivers, wherein each of the plurality of IO drivers is to tunnel traffic through a shared physical interface in accordance with a different protocol. The technology also determines, based on the state data, a bandwidth allocation of the shared physical interface among the plurality of IO drivers, and automatically initiates, based on the bandwidth allocation, a state change of a processor coupled to the shared physical interface

### TECHNICAL FIELD

Embodiments generally relate to converged input/output (IO) connection management. More particularly, embodiments relate to influencing processor governance based on serial bus converged IO connection management.

### BACKGROUND

Recent developments in USB (Universal Serial Bus, e.g., USB4 Specification, Version 1.0, August 2019, USB 3.0 Promoter Group) technology may support the use of different high speed transport protocols to tunnel IO traffic through a shared USB hub (e.g., in a converged IO/CIO architecture). In such a case, a connection manager may manage the allocation of bandwidth across the various transport protocols in use. Conventional connection manager solutions, however, may result in ineffective power and performance management of tunneled IO transactions. For example, the connection manager may select a bandwidth allocation that results in a relatively low priority protocol experiencing starvation conditions (e.g., insufficient lane assignments) and/or failures.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a multi-level scheduling architecture for tunneled paths according to an embodiment;

FIG. 2 is an illustration of an example of a converged IO architecture according to an embodiment;

FIG. 3 is a block diagram of an example of a feedback loop according to an embodiment;

FIG. 4 is a flowchart of an example of a method of operating a performance-enhanced computing system according to an embodiment;

FIG. 5 is a block diagram of an example of a more detailed converged IO architecture according to an embodiment;

FIG. 6 is a block diagram of an example of a performance-enhanced computing system according to an embodiment;

FIG. 7 is an illustration of an example of a semiconductor apparatus according to an embodiment;

FIG. 8 is a block diagram of an example of a processor according to an embodiment; and

FIG. 9 is a block diagram of an example of a multi-processor based computing system according to an embodiment.

### DESCRIPTION OF EMBODIMENTS

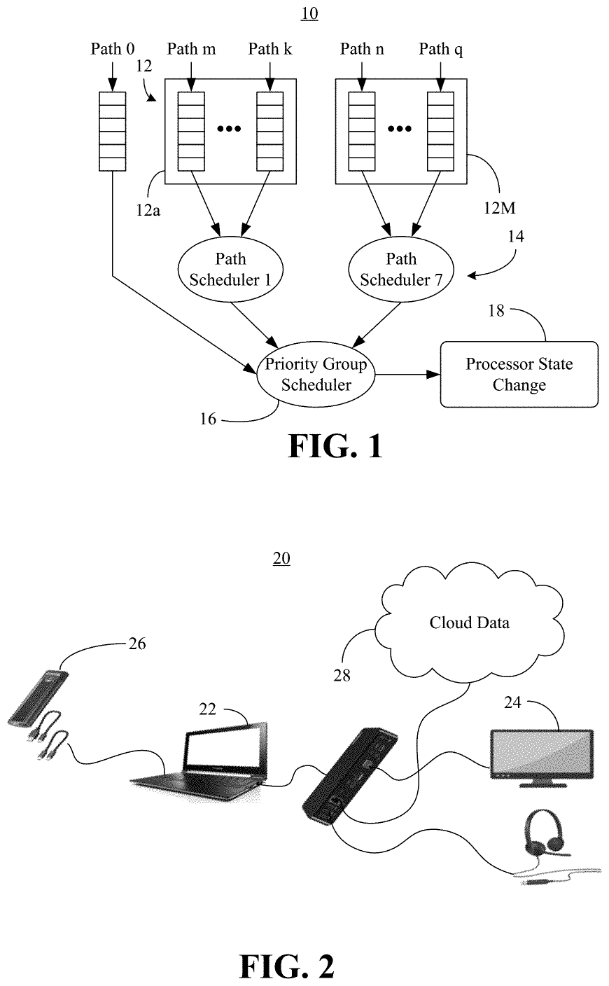

Turning now to FIG. 1, a multi-level scheduling architecture 10 is shown in which tunneling paths (e.g., “Path m,” “Path k,” “Path n,” “Path q,” with the exception of a high priority “Path 0”) are organized into priority groups 12 (12a-12M). In general, a connection manager (not shown) may set up the tunneling paths for different protocols such as, for example, display protocols (e.g., DisplayPort/DP Standard, Version 2.0, Jun. 26, 2019, Video Electronics Standards Association), storage protocols (e.g., USB Specification 3.1, Rev. 1.0, Jul. 26, 2013, USB Implementers Forum), network protocols (e.g., Peripheral Components Interconnect Express/PCIe, PCI EXPRESS Base Specification 5.0, Version 1.0, May 28, 2019, PCI Special Interest Group), and so forth.

In an embodiment, the tunneling paths pass through a shared physical interface such as, for example, a USB hub (not shown). In one example, each group 12 is assigned a priority, with the highest priority group 12 being scheduled first by a priority group scheduler 16. Additionally, within each group 12, every path may be provided a weight that is used by path schedulers 14 to perform round robin scheduling. Thus, a path with weight X might have X packets scheduled for the path in a given round. In the illustrated example, the path scheduling and group scheduling information is used to initiate/trigger a state change 18 (e.g., clock frequency, operating voltage, power state and/or performance state change) in a processor (e.g., host processor, central processing unit/CPU, not shown) coupled to the shared physical interface. As will be discussed in greater detail, the state change 18 may prevent starvation conditions (e.g., insufficient lane assignments) and/or failures (e.g., user-visible failures) with respect to the different protocols. The illustrated solution therefore enables enhanced performance to be achieved in a converged IO architecture.

FIG. 2 shows a converged IO architecture 20 in which a computing system 22 uses a shared physical interface to tunnel traffic (e.g., data, instructions) to a high resolution display 24 in accordance with a display protocol (e.g., DP), a high bandwidth storage device 26 (e.g., storage device that complies with Non-Volatile Memory/NVM EXPRESS Base Specification, Revision 1.4, Jun. 10, 2019) in accordance with a storage protocol (e.g., PCIe), a cloud computing infrastructure 28 in accordance with a network protocol (e.g., Ethernet over USB 3.0/USB3), and so forth. In an embodiment, the display protocol tunnels carry periodic information such as, for example, isochronous information and interrupts. The storage protocol and network protocol tunnels, by contrast, may carry aperiodic information (e.g., control information, bulk information) in addition to periodic information. In one example, the periodic transfers are provided with a definite service opportunity (e.g., Path 0 in FIG. 1), whereas the aperiodic transfers are scheduled using round robin scheduling within a priority group 12 (FIG. 1, e.g., the fastest transfer on an otherwise idle bus). Therefore, the connection manager may prioritize the display protocol over the storage protocol and prioritize the storage protocol over the network protocol in terms of bandwidth.

If the computing system 22 is conducting an active user activity such as, for example, playing a game served by the cloud computing infrastructure 28 and presenting the game on the display 24, while syncing data into the storage device 26, such a scenario may involve all three tunnel protocols being in peak usage (e.g., leading to a high bandwidth requirement). In such a case, the priority given to isochronous (e.g., display and/or audio activity) might lead to starvation of the storage or other USB activities. To prevent starvation conditions and other failures, knowledge of the USB4 tunneled protocol bandwidth requirements (e.g., and potential performance bottlenecks) are communicated from the connection manager to processor governors, which may change the operating state of the processor. The result is more effective management of processor capabilities for better performance and power conservation.

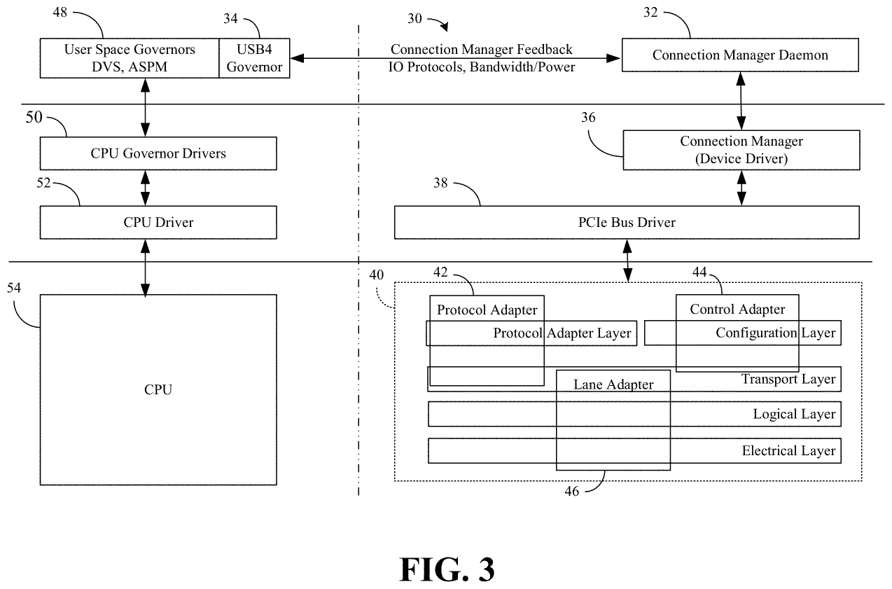

Turning now to FIG. 3, a feedback loop 30 is shown between a connection manager daemon 32 and a USB4 governor 34 (e.g., in a Linux architecture). In the illustrated example, the connection manager daemon 32 uses a connection manager 36 (e.g., device driver) to communicate with a PCIe bus driver 38. The PCIe bus driver 38 may communicate with a software stack 40 that includes a protocol adapter 42 (e.g., implemented at a protocol adapter layer and a transport layer), a control adapter 44 (e.g., implemented at a configuration layer and the transport layer), and a lane adapter 46 (e.g., implemented at the transport layer, a logical layer, and an electrical layer).

In an embodiment, the USB4 governor 34 is coupled to user space governors 48 such as, for example, a dynamic voltage and frequency scaling (DVFS) governor and/or an active state power management (ASPM) governor. The user space governors 48 may change the operating state of a CPU 54 via CPU governor drivers 50 and a CPU driver 52. In the illustrated example, the feedback loop 30 includes connection manager feedback such as, for example, the bandwidth/power needs of the IO protocols in use. Accordingly, the state changes conducted by the user space governors 48 may be initiated and/or triggered by the connection manager 36 through the feedback loop 30 to prevent starvation conditions, failures, and so forth.

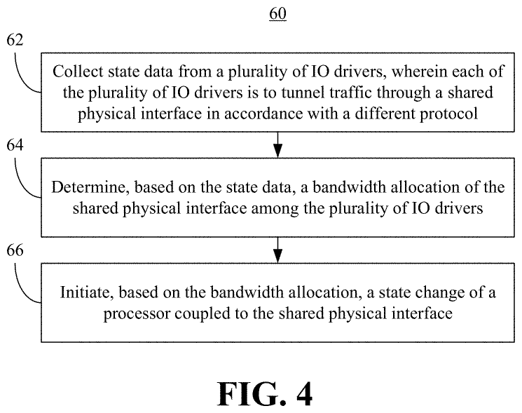

FIG. 4 shows a method 60 of operating a performance-enhanced computing system. The method 60 may generally be implemented in a connection manager such as, for example, the connection manager 36 (FIG. 3), already discussed. More particularly, the method 60 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 60 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for collecting state data from a plurality of IO drivers, wherein each of the plurality of IO drivers is to tunnel traffic through a shared physical interface in accordance with a different protocol. The state data may generally indicate the level of activity and/or bandwidth demand from the different protocols and/or drivers. For example, block 62 might include collecting state data from a first IO driver, wherein the first IO driver tunnels traffic in accordance with a display protocol (e.g., DP handling periodic information). Block 62 may also collect state data from a second IO driver, wherein the second IO driver tunnels traffic in accordance with a storage protocol (e.g., USB handling periodic and/or aperiodic information). In another example, block 62 includes collecting state data from a third IO driver, wherein the third IO driver tunnels traffic in accordance with a network protocol (e.g., PCIe handling aperiodic information).

Block 64 provides for determining, based on the collected state data, a bandwidth allocation of the shared physical interface among the plurality of IO drivers. In an embodiment, block 64 includes prioritizing the display protocol over the storage protocol. Additionally, block 64 may prioritize the storage protocol over the network protocol. In one example, the bandwidth allocation specifies (e.g., in terms of bits per second/bps, lanes, etc.) the amount of bandwidth allocated to the respective protocols, drivers and/or tunnels. Illustrated block 66 provides for automatically initiating, based on the bandwidth allocation, a state change of a processor coupled to the shared physical interface. The state change may include an increase or decrease in, for example, a clock frequency, an operating voltage, a power state (e.g., Advanced Configuration and Power Interface/ACPI power state), a performance state (e.g., ACPI performance state), etc., or any combination thereof. In an embodiment, the state change prevents one or more of a starvation condition or a failure in at least one of the plurality of IO drivers.

Thus, when block 66 detects high bandwidth usage, the processor governors may be influenced and/or instructed to improve the processor performance and ensure that the bandwidth allocation is effective in improving the performance of the tunneled protocols. Subsequently, when the block 66 detects that the tunneled protocols are less bandwidth intensive, the processor governors may be influenced/instructed to enter a power conserving mode. Alternatively, block 66 may also adopt a “race to halt” mode when data (e.g., storage rather than display) intensive operation is detected in a protocol. Such an approach increases the processor clock to complete the data transfers quickly, followed by a halt to save power.

In another example, if a PCIe-based network card is used in a system along with a USB3 high-resolution webcam, block 64 may treat the PCIe traffic as a non-isochronous transfer, which will not receive guaranteed bandwidth in the shared physical interface. By contrast, block 64 may treat the USB3 traffic as an isochronous transfer that receives guaranteed bandwidth in the shared physical interface. In such a case, block 66 might instruct the processor frequency scaling governor to switch to a higher frequency. Experimental results show an unexpected 41% increase (from 57 Gbps to 79 Gbps) of TCP (Transmission Control Protocol) throughput on the PCIe network card, when switching to a “performance” governor from a “powersave” governor in such a case. The illustrated method 60 may also be useful in improving block read and write throughput when using, for example, an NVM EXPRESS solid state drive (SSD) as secondary storage. The method 60 therefore enhances performance at least in terms of fewer starvation conditions and/or failures in a converged IO architecture.

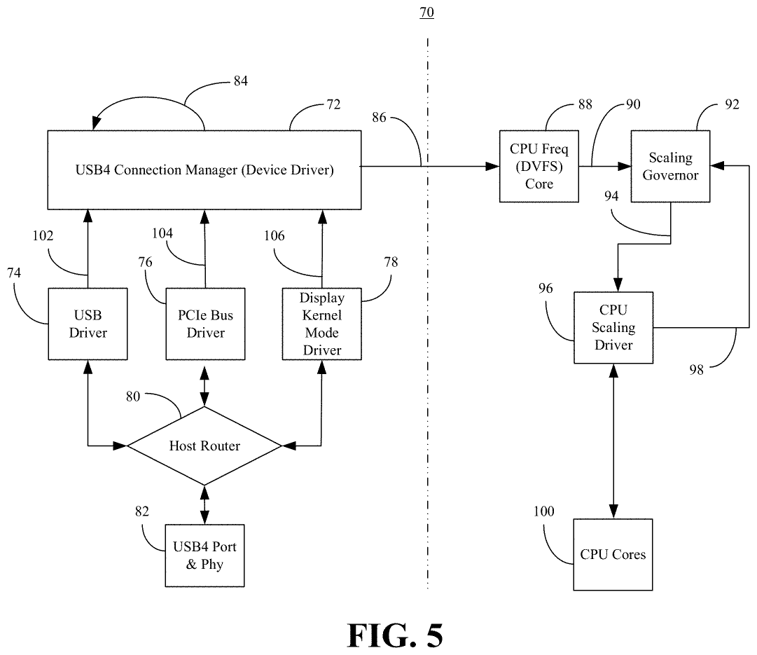

FIG. 5 shows a more detailed converged IO architecture 70. In the illustrated example, a USB4 connection manager 72 (e.g., including logic instructions, configurable logic, fixed-functionality hardware logic, etc., or any combination thereof) sets up a USB driver 74, a PCIe bus driver 76, and a display kernel mode driver 78 to tunnel USB4 packets into a host router 80, which is coupled to a USB4 port and physical layer (Phy) 82. The connection manager 72 may collect periodic/aperiodic usage state data 102 from the USB driver 74, high bandwidth device state data 104 from the PCIe bus driver 76, and high resolution state data 106 from the display kernel mode driver 78. The connection manager 72 may then compute 84 overall bandwidth usage for the USB driver 74, the PCIe bus driver 76, and the display kernel mode driver 78.

In an embodiment, the connection manager 72 triggers 86 a switch between performance and power save governors. Upon detecting the switch, a CPU frequency (e.g., DVFS) core 88 obtains 90 P-state information for a scaling governor 92. In one example, the scaling governor 92 issues 94 a scale up or scale down signal to a CPU scaling driver 96, which in turn sends 98 available P-states for a CPU group back to the scaling governor 92. The CPU scaling driver 96 may communicate directly with one or more CPU cores 100.

Thus, the connection manager 72 leverages knowledge of the various protocol drivers to manage the bandwidth allocation and other IO functionalities. As already noted, between the IO groups, DP may be part of the highest priority group, followed by USB3 and PCIe sharing the next lower priority group. Within the USB3 & PCIe priority group, USB3 may receive higher round-robin weightage and have bandwidth reserved for isochronous transfers.

For example, considering a bandwidth allocation out of 40 Gbps (e.g., in decreasing order) DP, which is all isochronous, may receive 80% of the bandwidth allocation, depending on the number of DP links (e.g., up to two) and the number of lanes per link (e.g., up to four, with one DP link).

Bandwidth=Link Rate*Lane-count* 8/10

For example, for high bit rate (HBR) 3×4 Lanes: Bandwidth=8.1 Gbps*4*0.8=25.92 Gbps

The remaining bandwidth for the periodic/aperiodic usage from the USB driver 74 may be used at a maximum 20 Gbps and the high bandwidth device usage from the PCIe bus driver 76 may be up to sixteen lanes (e.g., NVME storage device). Accordingly, the connection manager 72 may determine the bandwidth remaining and the class level activities of the USB driver 74 and the PCIe bus driver 76 to determine the functionalities configured on top of these IO protocols. The connection manager 72 also compares this information with bandwidth health and failure information. Based on these inputs, when the activity is high, the illustrated connection manager 72 instructs the processor governor to switch to performance mode (e.g., “turbo” mode). The connection manager 72 may also directly skew the clock to a higher value to improve the bandwidth health. Finally, when the connection manager 72 determines that the activity on the tunneled protocols is reduced or disconnected, the connection manager 72 may instruct the processor governors to switch to “powersave” or instruct frameworks managing the IO framework (e.g., ASPM) to switch to low power modes.

As already noted, the connection manager 72 may alternatively conserve energy during operation by adopting a race to halt mode on high data transfer operations. Such a mode may be achieved by skewing the clock to higher performance, completing data intensive transfers and then entering a power saving mode.

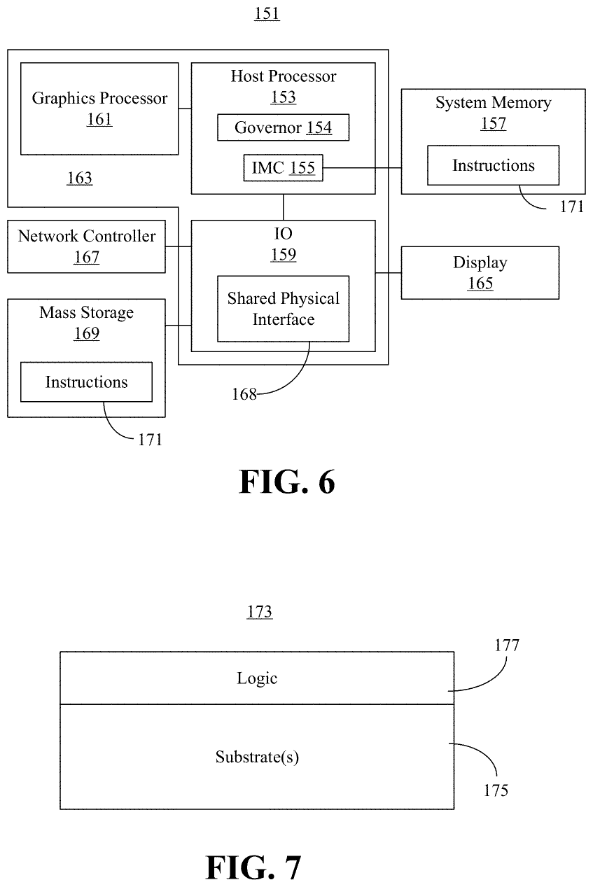

Turning now to FIG. 6, a performance-enhanced computing system 151 is shown. The system 151 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 151 includes a host processor 153 (e.g., CPU) having a governor 154 and an integrated memory controller (IMC) 155 that is coupled to a system memory 157.

The illustrated system 151 also includes an input output (IO) module 159 implemented together with the host processor 153 and a graphics processor 161 (e.g., graphics processing unit/GPU) on a semiconductor die 163 as a system on chip (SoC). The illustrated IO module 159 communicates with, for example, a display 165 (e.g., touch screen, liquid crystal display/LCD, light emitting diode/LED display), a network controller 167 (e.g., wired and/or wireless), and mass storage 169 (e.g., hard disk drive/HDD, optical disk, solid state drive/SSD, flash memory). The IO module 159 may also include a shared physical interface 168 (e.g., USB hub).

In an embodiment, the host processor 153, the graphics processor 161 and/or the IO module 159 execute connection manager program instructions 171 retrieved from the system memory 157 and/or the mass storage 169 to perform one or more aspects of the method 60 (FIG. 4), already discussed. Thus, execution of the illustrated instructions 171 may cause the computing system 151 to collect state data from a plurality of IO drivers, wherein each of the IO drivers is to tunnel traffic through the shared physical interface 168 in accordance with a different protocol. For example, a first IO driver may tunnel traffic to the display 165 in accordance with a display protocol, a second IO driver may tunnel traffic to the mass storage 169 in accordance with a storage protocol, a third IO driver may tunnel traffic to the network controller 167 in accordance with a network protocol, and so forth. The computing system 151 may also support THUNDERBOLT interfaces and the daisy-chaining of devices (e.g., in a host-to-host configuration).

Execution of the instructions 171 may also cause the computing system 151 to determine, based on the state data, a bandwidth allocation of the shared physical interface 168 among the plurality of IO drivers. In an embodiment, the bandwidth allocation prioritizes the display protocol over the storage protocol. The bandwidth allocation may also prioritize the storage protocol over the network protocol. In one example, execution of the instructions 171 causes the computing system 151 to initiate a state change (e.g., clock frequency change, operating voltage change, power state change, performance state change, etc.) of the host processor 153 based on the bandwidth allocation. The state change, which may be triggered via one or more instructions to the governor 154, prevents a starvation condition and/or a failure in at least one of the plurality of IO drivers. The computing system 151 is therefore considered performance-enhanced at least to the extent that it encounters fewer starvation conditions and/or failures in a converged IO architecture.

FIG. 7 shows a semiconductor package apparatus 173. The illustrated apparatus 173 includes one or more substrates 175 (e.g., silicon, sapphire, gallium arsenide) and logic 177 (e.g., transistor array and other integrated circuit/IC components) coupled to the substrate(s) 175. The logic 177 may be implemented at least partly in configurable logic or fixed-functionality logic hardware. In one example, the logic 177 implements one or more aspects of the method 60 (FIG. 4), already discussed. Thus, the logic 177 may collect state data from a plurality of IO drivers, wherein each of the IO drivers is to tunnel traffic through a shared physical interface in accordance with a different protocol. For example, a first IO driver may tunnel traffic to a display in accordance with a display protocol, a second IO driver may tunnel traffic to a mass storage in accordance with a storage protocol, a third TO driver may tunnel traffic to a network controller in accordance with a network protocol, and so forth.

The logic 177 may also determine, based on the state data, a bandwidth allocation of the shared physical interface among the plurality of TO drivers. In an embodiment, the bandwidth allocation prioritizes the display protocol over the storage protocol. The bandwidth allocation may also prioritize the storage protocol over the network protocol. In one example, the logic 177 initiates a state change (e.g., clock frequency change, operating voltage change, power state change, performance state change, etc.) of a processor (e.g., host processor, graphics processor) based on the bandwidth allocation. The state change, which may be triggered via one or more instructions to a governor, prevents a starvation condition and/or a failure in at least one of the plurality of TO drivers. The apparatus 173 is therefore considered performance-enhanced at least to the extent that it encounters fewer starvation conditions and/or failures in a converged TO architecture.

In one example, the logic 177 includes transistor channel regions that are positioned (e.g., embedded) within the substrate(s) 175. Thus, the interface between the logic 177 and the substrate(s) 175 may not be an abrupt junction. The logic 177 may also be considered to include an epitaxial layer that is grown on an initial wafer of the substrate(s) 175.

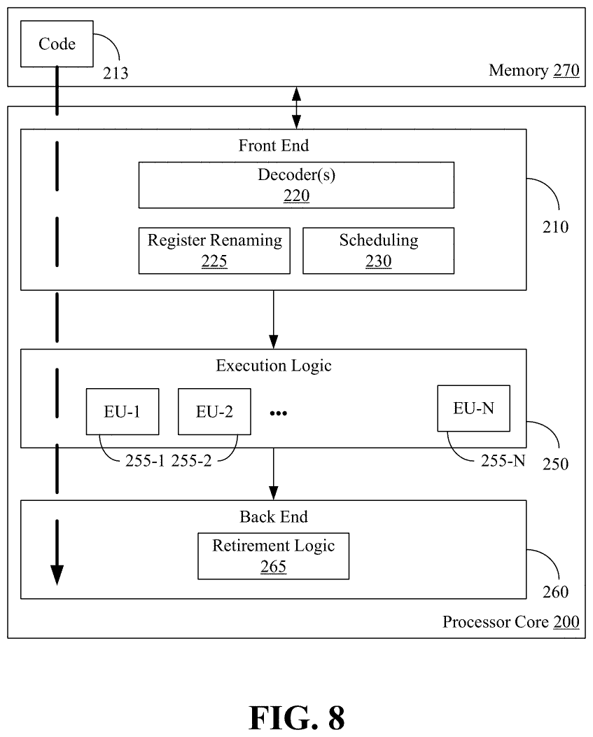

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 60 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

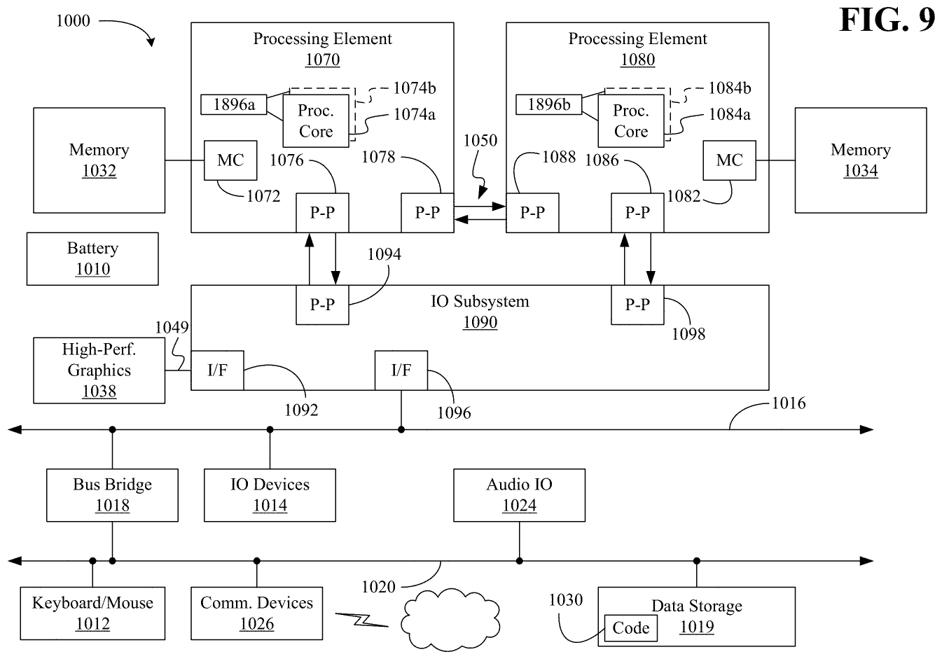

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the method 60 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### Additional Notes and Examples

Example 1 includes a performance-enhanced computing system comprising an input/output (IO) module including a shared physical interface, a processor coupled to the IO module, and a memory coupled to the processor and the IO module, the memory comprising a set of executable program instructions, which when executed by the IO module, cause the computing system to collect state data from a plurality of IO drivers, wherein each of the plurality of IO drivers is to tunnel traffic through the shared physical interface in accordance with a different protocol, determine, based on the state data, a bandwidth allocation of the shared physical interface among the plurality of IO drivers, and initiate a state change of the processor based on the bandwidth allocation.

Example 2 includes the computing system of Example 1, wherein the state change is to prevent one or more of a starvation condition or a failure in at least one of the plurality of IO drivers.

Example 3 includes the computing system of Example 1, wherein the state change is to include one or more of a clock frequency change, an operating voltage change, a power state change or a performance state change.

Example 4 includes the computing system of any one of Examples 1 to 3, wherein the state data is to be collected from a first IO driver, a second IO driver, and a third IO driver, wherein the first IO driver is to tunnel traffic in accordance with a display protocol, wherein the second IO driver is to tunnel traffic in accordance with a storage protocol, and wherein the third IO driver is to tunnel traffic in accordance with a network protocol.

Example 5 includes the computing system of Example 4, wherein the bandwidth allocation is to prioritize the display protocol over the storage protocol.

Example 6 includes the computing system of Example 5, wherein the bandwidth allocation is to further prioritize the storage protocol over the network protocol.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to collect state data from a plurality of input/output (TO) drivers, wherein each of the plurality of IO drivers is to tunnel traffic through a shared physical interface in accordance with a different protocol, determine, based on the state data, a bandwidth allocation of the shared physical interface among the plurality of IO drivers, and initiate, based on the bandwidth allocation, a state change of a processor coupled to the shared physical interface.

Example 8 includes the semiconductor apparatus of Example 7, wherein the state change is to prevent one or more of a starvation condition or a failure in at least one of the plurality of IO drivers.

Example 9 includes the semiconductor apparatus of Example 7, wherein the state change is to include one or more of a clock frequency change, an operating voltage change, a power state change or a performance state change.

Example 10 includes the semiconductor apparatus of any one of Examples 7 to 9, wherein the state data is to be collected from a first IO driver, a second IO driver, and a third IO driver, wherein the first IO driver is to tunnel traffic in accordance with a display protocol, wherein the second IO driver is to tunnel traffic in accordance with a storage protocol, and wherein the third IO driver is to tunnel traffic in accordance with a network protocol.

Example 11 includes the semiconductor apparatus of Example 10, wherein the bandwidth allocation is to prioritize the display protocol over the storage protocol, and wherein the bandwidth allocation is to further prioritize the storage protocol over the network protocol.

Example 12 includes the semiconductor apparatus of Example 7, wherein the logic coupled to the one or more substrates includes transistor channel regions that are positioned within the one or more substrates.

Example 13 includes at least one computer readable storage medium comprising a set of executable program instructions, which when executed by a computing system, cause the computing system to collect state data from a plurality of input/output (TO) drivers, wherein each of the plurality of IO drivers is to tunnel traffic through a shared physical interface in accordance with a different protocol, determine, based on the state data, a bandwidth allocation of the shared physical interface among the plurality of IO drivers, and initiate, based on the bandwidth allocation, a state change of a processor coupled to the shared physical interface.

Example 14 includes the at least one computer readable storage medium of Example 13, wherein the state change is to prevent one or more of a starvation condition or a failure in at least one of the plurality of IO drivers.

Example 15 includes the at least one computer readable storage medium of Example 13, wherein the state change is to include one or more of a clock frequency change, an operating voltage change, a power state change or a performance state change.

Example 16 includes the at least one computer readable storage medium of any one of Examples 13 to 15, wherein the state data is to be collected from a first IO driver, a second IO driver, and a third IO driver, wherein the first IO driver is to tunnel traffic in accordance with a display protocol, wherein the second IO driver is to tunnel traffic in accordance with a storage protocol, and wherein the third IO driver is to tunnel traffic in accordance with a network protocol.

Example 17 includes the at least one computer readable storage medium of Example 16, wherein the bandwidth allocation is to prioritize the display protocol over the storage protocol.

Example 18 includes the at least one computer readable storage medium of Example 17, wherein the bandwidth allocation is to further prioritize the storage protocol over the network protocol.

Example 19 includes a method of operating a performance-enhanced computing system, the method comprising collecting state data from a plurality of input/output (TO) drivers, wherein each of the plurality of IO drivers tunnels traffic through a shared physical interface in accordance with a different protocol, determining, based on the state data, a bandwidth allocation of the shared physical interface among the plurality of IO drivers, and initiating, based on the bandwidth allocation, a state change of a processor coupled to the shared physical interface.

Example 20 includes the method of Example 19, wherein the state change prevents one or more of a starvation condition or a failure in at least one of the plurality of IO drivers.

Example 21 includes the method of Example 19, wherein the state change includes one or more of a clock frequency change, an operating voltage change, a power state change or a performance state change.

Example 22 includes the method of any one of Examples 19 to 21, wherein the state data is collected from a first IO driver, a second IO driver, and a third IO driver, wherein the first IO driver tunnels traffic in accordance with a display protocol, wherein the second IO driver tunnels traffic in accordance with a storage protocol, and wherein the third IO driver tunnels traffic in accordance with a network protocol.

Example 23 includes the method of Example 22, wherein the bandwidth allocation prioritizes the display protocol over the storage protocol.

Example 24 includes the method of Example 23, wherein the bandwidth allocation further prioritizes the storage protocol over the network protocol.

Example 25 includes an apparatus comprising means for performing the method of any one of Examples 19 to 24.

Thus, technology described herein may influence PCIe active-state power management (ASPM) for performance and power. The technology may also influence CPU governors for clock (e.g., performance) to improve USB class performance. As a result, the technology compensates the bandwidth needs of tunneled protocols to ensure seamless tunneling without starvation or failures. Thus, a better user experience is achieved with better performance.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
an input/output (TO) module including a shared physical interface;
a processor coupled to the IO module; and
a memory coupled to the processor and the IO module, the memory comprising a set of executable program instructions, which when executed by the IO module, cause the computing system to:
collect state data from a plurality of IO drivers, wherein each of the plurality of IO drivers is to tunnel traffic through the shared physical interface in accordance with a different protocol;
determine, based on the state data, a bandwidth allocation of the shared physical interface among the plurality of IO drivers; and
initiate a state change of the processor based on the bandwidth allocation.

2. The computing system of claim 1, wherein the state change is to prevent one or more of a starvation condition or a failure in at least one of the plurality of IO drivers.

3. The computing system of claim 1, wherein the state change is to include one or more of a clock frequency change, an operating voltage change, a power state change or a performance state change.

4. The computing system of claim 1, wherein the state data is to be collected from a first IO driver, a second IO driver, and a third IO driver, wherein the first IO driver is to tunnel traffic in accordance with a display protocol, wherein the second IO driver is to tunnel traffic in accordance with a storage protocol, and wherein the third IO driver is to tunnel traffic in accordance with a network protocol.

5. The computing system of claim 4, wherein the bandwidth allocation is to prioritize the display protocol over the storage protocol.

6. The computing system of claim 5, wherein the bandwidth allocation is to further prioritize the storage protocol over the network protocol.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
collect state data from a plurality of input/output (TO) drivers, wherein each of the plurality of IO drivers is to tunnel traffic through a shared physical interface in accordance with a different protocol;
determine, based on the state data, a bandwidth allocation of the shared physical interface among the plurality of IO drivers; and
initiate, based on the bandwidth allocation, a state change of a processor coupled to the shared physical interface.

8. The semiconductor apparatus of claim 7, wherein the state change is to prevent one or more of a starvation condition or a failure in at least one of the plurality of IO drivers.

9. The semiconductor apparatus of claim 7, wherein the state change is to include one or more of a clock frequency change, an operating voltage change, a power state change or a performance state change.

10. The semiconductor apparatus of claim 7, wherein the state data is to be collected from a first IO driver, a second IO driver, and a third IO driver, wherein the first IO driver is to tunnel traffic in accordance with a display protocol, wherein the second IO driver is to tunnel traffic in accordance with a storage protocol, and wherein the third TO driver is to tunnel traffic in accordance with a network protocol.

11. The semiconductor apparatus of claim 10, wherein the bandwidth allocation is to prioritize the display protocol over the storage protocol, and wherein the bandwidth allocation is to further prioritize the storage protocol over the network protocol.

12. The semiconductor apparatus of claim 7, wherein the logic coupled to the one or more substrates includes transistor channel regions that are positioned within the one or more substrates.

13. At least one computer readable storage medium comprising a set of executable program instructions, which when executed by a computing system, cause the computing system to:
collect state data from a plurality of input/output (TO) drivers, wherein each of the plurality of TO drivers is to tunnel traffic through a shared physical interface in accordance with a different protocol;
determine, based on the state data, a bandwidth allocation of the shared physical interface among the plurality of TO drivers; and
initiate, based on the bandwidth allocation, a state change of a processor coupled to the shared physical interface.

14. The at least one computer readable storage medium of claim 13, wherein the state change is to prevent one or more of a starvation condition or a failure in at least one of the plurality of TO drivers.

15. The at least one computer readable storage medium of claim 13, wherein the state change is to include one or more of a clock frequency change, an operating voltage change, a power state change or a performance state change.

16. The at least one computer readable storage medium of claim 13, wherein the state data is to be collected from a first TO driver, a second TO driver, and a third TO driver, wherein the first TO driver is to tunnel traffic in accordance with a display protocol, wherein the second TO driver is to tunnel traffic in accordance with a storage protocol, and wherein the third TO driver is to tunnel traffic in accordance with a network protocol.

17. The at least one computer readable storage medium of claim 16, wherein the bandwidth allocation is to prioritize the display protocol over the storage protocol.

18. The at least one computer readable storage medium of claim 17, wherein the bandwidth allocation is to further prioritize the storage protocol over the network protocol.

19. A method comprising:
collecting state data from a plurality of input/output (TO) drivers, wherein each of the plurality of TO drivers tunnels traffic through a shared physical interface in accordance with a different protocol;
determining, based on the state data, a bandwidth allocation of the shared physical interface among the plurality of TO drivers; and
initiating, based on the bandwidth allocation, a state change of a processor coupled to the shared physical interface.

20. The method of claim 19, wherein the state change prevents one or more of a starvation condition or a failure in at least one of the plurality of TO drivers.

21. The method of claim 19, wherein the state change includes one or more of a clock frequency change, an operating voltage change, a power state change or a performance state change.

22. The method of claim 19, wherein the state data is collected from a first IO driver, a second IO driver, and a third IO driver, wherein the first IO driver tunnels traffic in accordance with a display protocol, wherein the second IO driver tunnels traffic in accordance with a storage protocol, and wherein the third IO driver tunnels traffic in accordance with a network protocol.

23. The method of claim 22, wherein the bandwidth allocation prioritizes the display protocol over the storage protocol.

24. The method of claim 23, wherein the bandwidth allocation further prioritizes the storage protocol over the network protocol.
